(19) United States
(12) Patent Application Publication
(10) Pub. No.: US 2011/0175557 A1
(43) Pub. Date: Jul. 21, 2011

(54) MOTOR DRIVING APPARATUS HAVING POWER REGENERATION FUNCTION

(75) Inventors: Yasusuke IWASHITA, Minamitsuru-gun (JP); Tadashi OKITA, Minamitsuru-gun (JP); Masakazu NIWA, Minamitsuru-gun (JP)

(73) Assignee: FANUC CORPORATION, Yamanashi (JP)

(21) Appl. No.: 12/965,432

(22) Filed: Dec. 10, 2010

(30) Foreign Application Priority Data
Jan. 20, 2010 (JP) 2010-010151

(51) Int. Cl. H02P 27/06

(52) U.S. Cl. 318/400.3

(57) ABSTRACT

A motor driving apparatus wherein provisions are made to ensure that the regenerative operation of a rectifier continues as long as the supply of power from an inverter continues, and that the regenerative operation of the rectifier stops when the supply of power from the inverter ends. The apparatus includes: a detection unit which detects an input voltage and current; an instantaneous effective power calculation unit which, based on the detected input voltage and current, calculates instantaneous effective power supplied from the rectifier to the inverter; a DC component calculation unit which, based on the value of the calculated power, calculates the DC component of the effective power; and a regenerative operation stopping decision unit which compares the value of the calculated DC component with a predetermined threshold value and decides that a power regeneration operation for feeding regenerative power from the inverter back into the power supply be stopped.

### BACKGROUND OF THE INVENTION

1. Field of the Invention

The present invention relates to a motor driving apparatus having a power regeneration function that feeds regenerative power recovered during motor deceleration back into a power supply line.

2. Description of the Related Art

In a motor driving apparatus employed in a machine tool, a forging press, an injection molding machine, an industrial robot, an industrial machine, etc., a rectifier (also referred to as a forward converter or AC-DC converter) is used that converts AC line power into DC power and that supplies the DC power to an inverter acting as a motor control power converter. With the recent trend toward energy conservation, rectifiers having a power regeneration function that feeds power generated during motor deceleration back into a power supply line, in particular, rectifiers of a 120-degree conduction type that can implement the power regeneration function at a relatively low cost, have been finding widespread use (refer, for example, to patent document 1 below).

Such a 120-degree conduction-type rectifier has two operation modes: a powering mode and regenerative mode. In the powering mode, power is supplied to an inverter through a three-phase bridge rectifier circuit constructed from an array of rectifying devices such as diodes. On the other hand, in the regenerative mode, a plurality of self-turn-off power devices such as IGBTs (Insulated Gate Bipolar mode Transistors) connected in inverse-parallel to the plurality of diodes in the three-phase bridge rectifier circuit are turned on and off according to the phase of the power supply so that the regenerative power from the inverter is fed back to the input power supply. The 120-degree conduction-type rectifier must be switched between the two operation modes according to the polarity of the power that passes through the rectifier.

Generally, a decision to switch from the regenerative mode to the powering mode is made based on the polarity of the instantaneous value of the effective power that passes through the rectifier. Accordingly, there can occur cases where the regenerative operation of the rectifier stops when the supply of the regenerative power from the inverter is still continuing. In that case, a voltage fluctuation occurs in the DC voltage output of the rectifier, causing ill effects on the motor control operation. Conversely, there can occur cases where the regenerative operation of the rectifier does not stop even after the supply of the regenerative power from the inverter has stopped. In that case, a ripple current flows between the AC power line and the smoothing capacitor in the driving apparatus, thus causing ill effects on the smoothing capacitor.

To address the above problem, patent document 2 below discloses a power regeneration converter equipped with a correcting means for correcting the regenerative current sampling phase based on which to make a decision to stop the regenerative operation. Patent document 2 claims that, with the provision of the correcting means, the regenerative operation can be performed and stopped reliably even in the presence of harmonic distortion in the supply voltage (see paragraphs 0013 and 0014 of patent document 2). In the proposed method, however, the decision is made by checking that the current value in the corrected regenerative current sampling phase drops below a predetermined value, but there is no guarantee that the regenerative operation will be stopped reliably with this decision. For a reliable regenerative operation stopping decision to be made, it is indispensable to monitor the effective power.
Patent document 1: Japanese Unexamined Patent Publication No. H06-62584
Patent document 2: Japanese Unexamined Patent Publication No. 2004-180427

### SUMMARY OF THE INVENTION

The present invention has been devised in view of the above problem, and an object of the invention is to provide a motor driving apparatus wherein provisions are made to ensure that the regenerative operation of the rectifier continues as long as the supply of the regenerative power from the inverter is continuing, and that the regenerative operation of the rectifier stops when the supply of the regenerative power from the inverter ends.

To achieve the above object, according to the present invention, there is provided a motor driving apparatus equipped with a rectifier for converting AC power from a three-phase AC input power supply into DC power and an inverter for converting the DC power into AC power of desired frequency, and configured to perform power regeneration by controlling the rectifier, and the motor driving apparatus includes: a detection unit which detects an input voltage and an input current supplied from the three-phase AC input power supply; an instantaneous effective power calculation unit which, based on the input voltage and input current detected by the detection unit, calculates instantaneous effective power supplied from the rectifier to the inverter; a DC component calculation unit which, based on the value of the power calculated by the instantaneous effective power calculation unit, calculates the DC component of the effective power supplied from the rectifier to the inverter; and a regenerative operation stopping decision unit which compares the value of the DC component, calculated by the DC component calculation unit, with a predetermined threshold value and which, if the value of the DC component is larger than the threshold value, decides that a power regeneration operation for feeding regenerative power from the inverter back into the three-phase AC input power supply be stopped.

In one preferred mode, the DC component calculation unit calculates the DC component by using a moving average filter or a first-order low-pass filter.

In one preferred mode, the instantaneous effective power calculation unit outputs as a calculation result a sum of products each obtained by multiplying together, on a phase-by-phase basis, the input voltage and input current supplied from the three-phase AC input power supply and detected by the detection unit.

Alternatively, the instantaneous effective power calculation unit outputs as a calculation result a sum of products each obtained by coordinate-transforming (α-β transforming) the input voltage and input current supplied from the three-phase AC input power supply, and detected by the detection unit, into a two-phase AC voltage and a two-phase AC current in a stationary coordinate system (α-β coordinate system) equivalent to the input voltage and the input current in a three-phase AC coordinate system, and by multiplying together the two-phase AC voltage and the two-phase AC current on a phase-by-phase basis.

Alternatively, the instantaneous effective power calculation unit outputs as a calculation result a sum of products each obtained by coordinate-transforming (α-β transforming) the input voltage and input current supplied from the three-phase AC input power supply, and detected by the detection unit, into a two-phase AC voltage and a two-phase AC current in a stationary coordinate system (α-β coordinate system) equivalent to the input voltage and the input current in a three-phase AC coordinate system, by coordinate-transforming (d-q transforming) the two-phase AC voltage and the two-phase AC current in the stationary coordinate system (α-β coordinate system) into a two-phase AC voltage and a two-phase AC current in a rotating coordinate system (d-q coordinate system) equivalent to the two-phase AC voltage and the two-phase AC current in the stationary coordinate system, and by multiplying together the two-phase AC voltage and the two-phase AC current in the rotating coordinate system (d-q coordinate system) on a phase-by-phase basis.

In the motor driving apparatus according to the present invention, based on the instantaneous effective power passing through the rectifier, the DC component (average power) of the effective power is extracted by removing harmonic components (ripple components) and, based on the DC component, a decision is made as to whether to switch from the regenerative operation to the powering operation. This ensures that the regenerative operation of the rectifier continues as long as the supply of the regenerative power from the inverter is continuing, and that the regenerative operation of the rectifier stops when the supply of the regenerative power from the inverter ends.

### BRIEF DESCRIPTION OF THE DRAWINGS

Further features and advantages of the present invention will be apparent from the following description with reference to the accompanying drawings, in which:

FIG. 1 is a block diagram showing one configuration example of a motor driving apparatus that uses a 120-degree conduction-type rectifier;

FIG. 2 is a diagram explaining the powering operation of the rectifier in the motor driving apparatus shown in FIG. 1;

FIG. 3 is a diagram explaining the regenerative operation of the rectifier in the motor driving apparatus shown in FIG. 1;

FIG. 4 is a time chart showing the on/off pattern of each semiconductor switch in the regenerative operation;

FIG. 5 is a diagram explaining the problem associated with the above prior art; and

FIG. 6 is a block diagram showing one embodiment of a motor driving apparatus according to the present invention.

### DETAILED DESCRIPTION

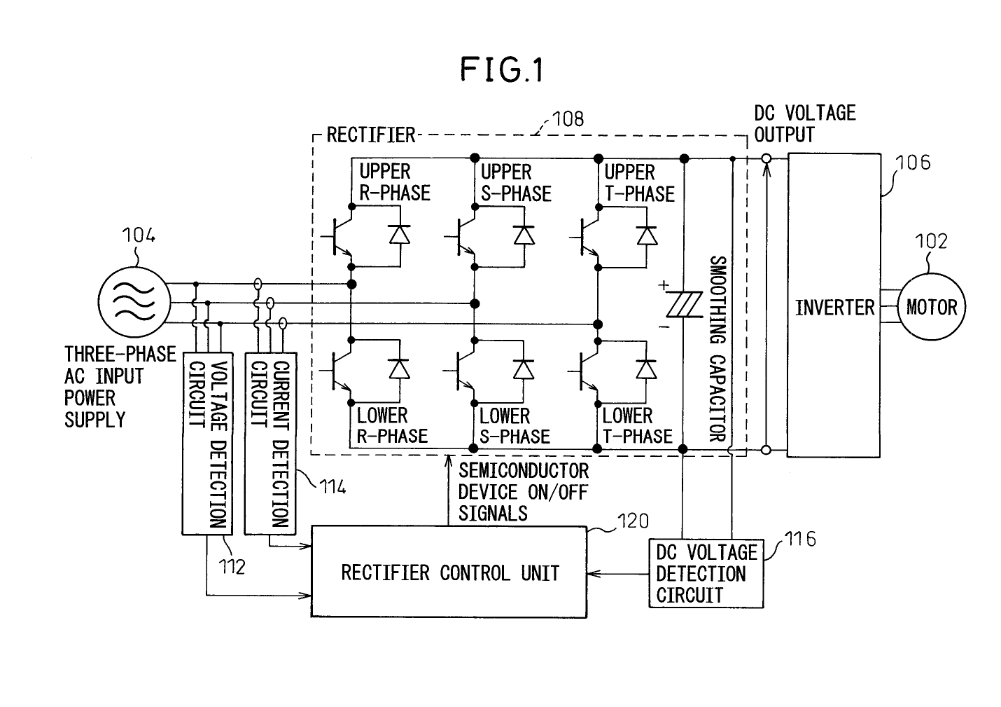

To facilitate understanding of the present invention, the regenerative operation of the rectifier in the motor driving apparatus and the problem associated with the prior art will be described with reference to FIGS. 1 to 5. FIG. 1 is a block diagram showing one configuration example of the motor driving apparatus that uses a 120-degree conduction-type rectifier. In FIG. 1, reference numeral 102 is a motor, 104 is a three-phase AC input power supply, 106 is an inverter, and 108 is the rectifier (only its main circuitry is shown here). Further, reference numeral 112 is a three-phase input voltage detection circuit, 114 is a three-phase input current detection circuit, 116 is a DC voltage detection circuit, and 120 is a rectifier control unit.

The rectifier 108 includes a three-phase bridge rectifying circuit and a smoothing capacitor. An IGBT (Insulated Gate Bipolar mode Transistor) as a self-turn-off semiconductor switch is connected in inverse-parallel to each diode in the three-phase bridge rectifying circuit. More specifically, the cathode of the diode is connected to the collector of the transistor, and the anode of the diode is connected to the emitter of the transistor. The rectifier 108 operates by switching between the powering mode and the regenerative mode.

The inverter 106 is, for example, a three-phase voltage source PWM inverter, and converts the DC power created by the rectifier 108 into AC power suitable for motor control. In the example shown in FIG. 1, only one inverter is provided, but a plurality of inverters may be connected in parallel between DC voltage output terminals.

The rectifier control unit 120 takes as inputs from the respective detection circuits 112, 114, and 116 the phase voltages and currents supplied from the three-phase input power supply 104 to the rectifier 108 and the DC voltage output from the rectifier 108. Then, the rectifier control unit 120 makes a decision to switch from the powering operation to the regenerative operation or from the regenerative operation to the powering operation, and outputs control signals for turning on or off the respective semiconductor switch devices in the rectifier 108.

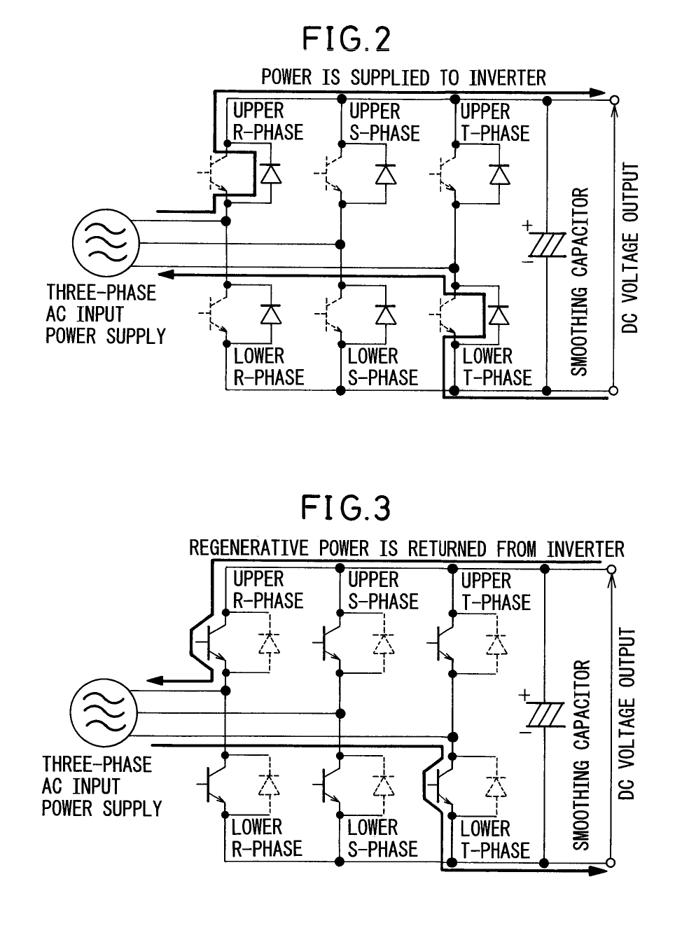

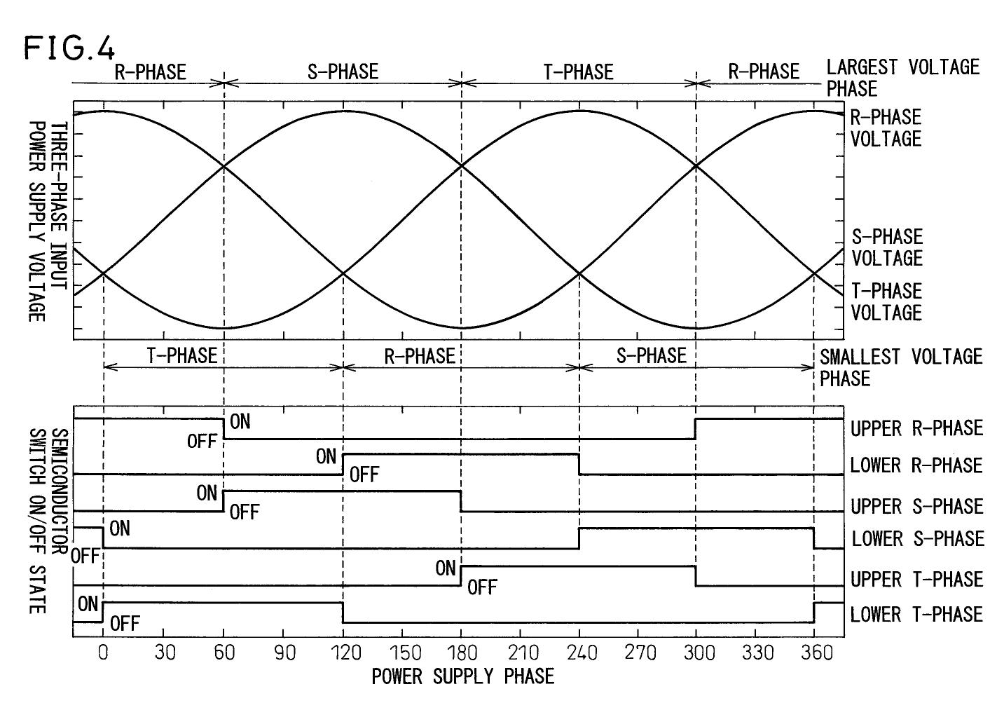

FIGS. 2 and 3 are diagrams explaining the powering operation and the regenerative operation, respectively, of the rectifier in the motor driving apparatus shown in FIG. 1. In the powering operation of the rectifier, i.e., in the operation for supplying electric power to the inverter, all the semiconductor switches (transistors) are turned off under the control of the rectifier control unit 120, and the electric power is supplied to the inverter through the diodes in the three-phase bridge rectifying circuit, as illustrated in FIG. 2. On the other hand, in the regenerative operation of the rectifier, i.e., in the operation for receiving electric power from the inverter, the regenerative power from the inverter is returned to the power supply, as illustrated in FIG. 3, with the rectifier control unit 120 controlling the on/off operation of the semiconductor switches according to the power supply phase.

FIG. 4 is a time chart showing the on/off pattern of each semiconductor switch in the regenerative operation. In the regenerative operation, of the three phase supply voltages, i.e., the R-phase voltage, the S-phase voltage, and the T-phase voltage, the semiconductor switch connected to the largest voltage phase and the semiconductor switch connected to the smallest voltage phase are turned on under the control of the rectifier control unit 120, and the other semiconductor switches are held off.

The largest voltage phase and the smallest voltage phase change according to the power supply phase, as illustrated in the time chart at the top of FIG. 4. Accordingly, the rectifier control unit 120 controls the on/off operation of the respective semiconductor switches, as illustrated in the time chart at the bottom of FIG. 4. Since each semiconductor switch conducts for a duration of 120 degrees, the mode is called the 120-degree conduction mode. The techniques disclosed in cited patent documents 1 and 2 concern improvements in control techniques for the 120-degree conduction mode.

Next, a description will be given of how the decision for switching the operation between the powering mode and the regenerative mode is made in the rectifier control unit 120. First, a description will be given of the decision making for initiating the regenerative operation, i.e., the condition based on which a decision is made to switch from the powering mode to the regenerative mode. When the rectifier 108 is operating in the powering mode, i.e., when all the semiconductor switches are off, if regenerative power is supplied from the inverter 106, the charge is stored on the smoothing capacitor, causing the potential at the DC voltage output of the rectifier 108 to increase. In the decision making process for initiating the regenerative operation, the DC voltage output is detected, and

(i) when the potential at the DC voltage output has exceeded a predetermined value, or

(ii) when the potential difference between the DC voltage output and the amplitude of phase-to-phase voltage of the three-phase input power supply has exceeded a predetermined value,

it is determined that the regenerative operation initiation condition holds.

Next, a description will be given of the decision making for stopping the regenerative operation, i.e., the condition based on which a decision is made to switch from the regenerative mode to the powering mode. When the supply of the regenerative power from the inverter 106 ends, the sign of the effective power that passes through the rectifier becomes “non-negative”. The convention used here is that the polarity is “positive” in the direction in which power is supplied to the inverter 106 and “negative” in the opposite direction. In the decision making process for stopping the regenerative operation, instantaneous effective power, i.e., the instantaneous value of the effective power, is detected, and

(i) when the value of the instantaneous effective power exceeds a predetermined value

it is determined that the regenerative operation stopping condition holds.

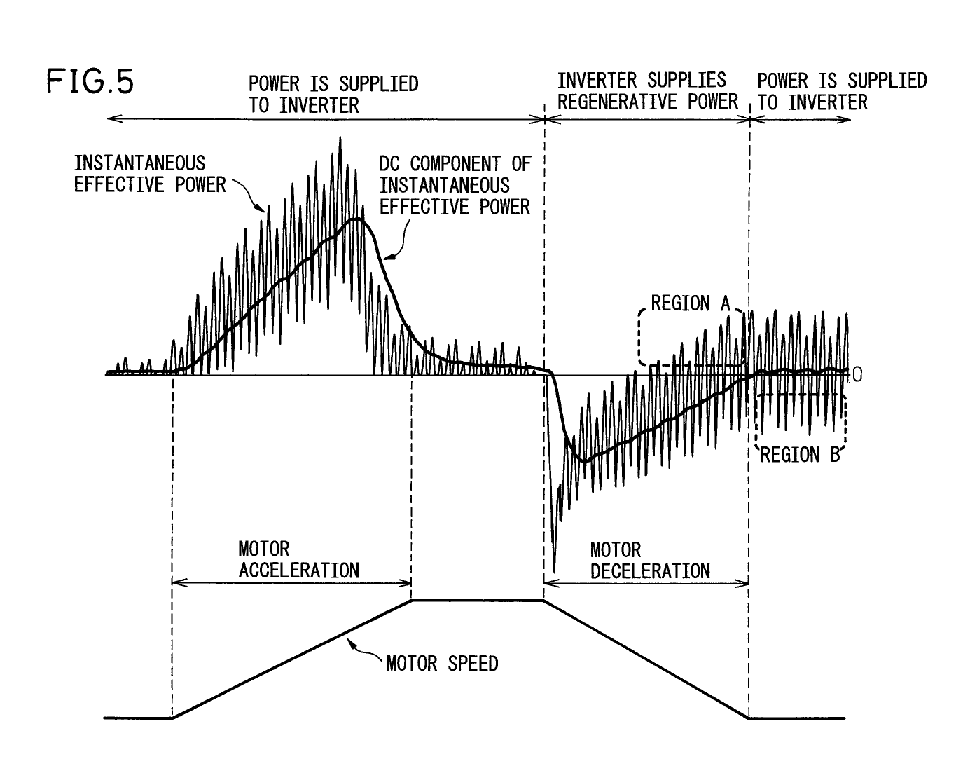

FIG. 5 is a diagram explaining the problem associated with the above prior art, showing an example of the waveform of the power that passes through the rectifier 108 when the motor 102 driven by the inverter 106 accelerates and decelerates. A current containing harmonic components flows into the 120-degree conduction-type rectifier. As a result, the instantaneous effective power that passes through the rectifier 108 has a waveform containing harmonic components (ripple components), as illustrated in FIG. 5.

After the motor 102 has begun to decelerate, and the rectifier 108 has switched to the regenerative operation mode, it is desirable that

(i) the regenerative operation of the rectifier continue throughout the period of motor deceleration (regenerative power is supplied from the inverter), and that

(ii) the regenerative operation of the rectifier stop upon stopping of the motor (upon completion of the supply of the regenerative power from the inverter).

If the decision for stopping the regenerative operation is made based on the value of the instantaneous effective power passing through the rectifier, it may be determined that the regenerative operation stopping condition holds, for example, in a region A, i.e., such a region that, though the polarity of the DC component is negative, that is, though, on average, the regenerative power is still being supplied from the inverter, the polarity of the instantaneous effective power becomes positive, because the ripple is larger than the DC component of the instantaneous effective power.

In this case, since the motor actually is still in the process of deceleration, and the inverter continues to supply regenerative power, the charge is stored on the smoothing capacitor and the DC voltage output rises. When the DC voltage output rises, the regenerative operation initiation condition holds, and the regeneration is started once again, whereupon the DC voltage output begins to fall. After that, when the polarity of the instantaneous effective power becomes positive, the regenerative operation stopping condition once again holds. Since this process is repeated, the DC voltage output greatly fluctuates, adversely affecting the current control operation of the inverter.

Immediately after the stopping of the motor, there follows a region B, i.e., such a region that, though the polarity of the DC component is positive, that is, though the power is being supplied from the three-phase input power supply to the inverter, the polarity of the instantaneous effective power becomes negative, because the ripple is larger than the DC component of the instantaneous effective power. As a result, if the cycle of the decision making for stopping the regenerative operation coincides with the cycle of the power ripple, a situation occurs where the regenerative operation stopping condition does not hold even after the stopping of the motor. In this case, a harmonic current continues to flow between the input power supply and the smoothing capacitor, causing ill effects on the smoothing capacitor.

In view of this, the present invention extracts the DC component (average power) by removing the harmonic components (ripple components) from the instantaneous effective power passing through the rectifier and, based on the polarity of the DC component, makes a decision as to whether or not to switch from the regenerative operation to the powering operation, thereby ensuring that

(i) the regenerative operation continues as long as the supply of the regenerative power from the inverter is continuing, and that

(ii) the regenerative operation stops when the supply of the regenerative power from the inverter ends.

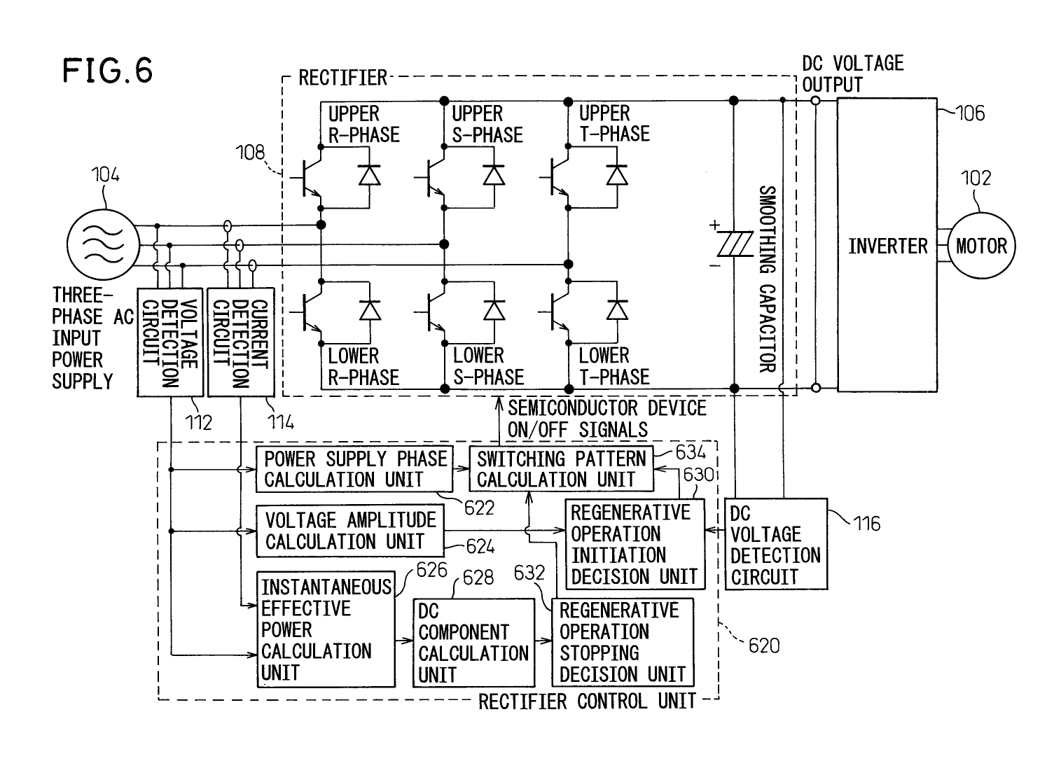

FIG. 6 is a block diagram showing one embodiment of a motor driving apparatus according to the present invention. In FIG. 6, the motor 102, three-phase AC input power supply 104, inverter 106, rectifier 108, three-phase input voltage detection circuit 112, three-phase input current detection circuit 114, and DC voltage detection circuit 116 are the same as those shown in FIG. 1.

On the other hand, a rectifier control unit 620 in the present embodiment includes a power supply phase calculation unit 622, a voltage amplitude calculation unit 624, an instantaneous effective power calculation unit 626, a DC component calculation unit 628, a regenerative operation initiation decision unit 630, a regenerative operation stopping decision unit 632, and a switching pattern calculation unit 634.

The power supply phase calculation unit 622 calculates the phase (electrical angle) in which the three-phase input power supply 104 is currently positioned, based on a change in the phase voltage (R phase, S phase, T phase) detected by the three-phase input voltage detection circuit 112. On the other hand, the voltage amplitude calculation unit 624 calculates the amplitude of phase-to-phase voltage of the three-phase input power supply 104, based on the respective phase voltages detected by the three-phase input voltage detection circuit 112.

Then, based on the DC voltage output detected by the DC voltage detection circuit 116 and the amplitude of phase-to-phase voltage of the three-phase input power supply calculated by the voltage amplitude calculation unit 624, the regenerative operation initiation decision unit 630 performs processing to determine that the regenerative operation initiation condition holds when the potential difference between the DC voltage output and the amplitude of phase-to-phase voltage exceeds a predetermined value.

Next, a description will be given of how the decision to stop the regenerative operation is made in the present embodiment. Based on the respective phase voltages detected by the three-phase input voltage detection circuit 112 and the respective phase currents detected by the three-phase input current detection circuit 114, the instantaneous effective power calculation unit 626 calculates the instantaneous effective power supplied from the three-phase input power supply 104 to the rectifier 108 and from the rectifier 108 to the inverter 106. For the calculation, the instantaneous effective power calculation unit 626 employs one of the following three calculation methods.

In the first instantaneous effective power calculation method, the input voltages vₐ, v_{b}, and v_{c} and input currents iₐ, i_{b}, and i_{c} supplied from the three-phase AC input power supply are multiplied together on a phase-by-phase basis, and the sum of the products is taken as the calculation result. More specifically, when the three-phase AC input voltage vector v_{abc} and three-phase AC input current vector i_{abc} of the rectifier 108 are respectively set as

$$\begin{matrix}{v}_{abc} = [ \begin{matrix}{v}_{a} \\ {v}_{b} \\ {v}_{c}\end{matrix} ] & ( 1 ) \\ {i}_{abc} = [ \begin{matrix}{i}_{a} \\ {i}_{b} \\ {i}_{c}\end{matrix} ] & ( 2 )\end{matrix}$$

the instantaneous effective power calculation unit 626 calculates the instantaneous effective power P as

P=vₐ·iₐ+v_{b}·i_{b}+v_{c}·i_{c}

In the second instantaneous effective power calculation method, the input voltages and input currents supplied from the three-phase AC input power supply are coordinate-transformed into two-phase AC voltages and two-phase AC currents in a stationary coordinate system (α-β coordinate system) equivalent to the input voltages and the input currents in the three-phase AC coordinate system (the process generally known as the α-β transformation); then, the two-phase AC voltages and the two-phase AC currents are multiplied together on a phase-by-phase basis, and the sum of the products is taken as the calculation result. More specifically, the instantaneous effective power calculation unit 626 applies the following coordinate transformation (α-β transformation) to the three-phase AC input voltage vector v_{abc} and three-phase AC input current vector i_{abc} of the rectifier 108 to transform them into the two-phase AC voltage vector v_{αβ} and two-phase AC current vector i_{αβ} in the stationary coordinate system.

$$\begin{matrix}{v}_{αβ} = [ \begin{matrix}{v}_{α} \\ {v}_{β}\end{matrix} ] = \sqrt{\frac{2}{3}} \cdot [ \begin{matrix}1 & - \frac{1}{2} & - \frac{1}{2} \\ 0 & \sqrt{\frac{3}{2}} & - \sqrt{\frac{3}{2}}\end{matrix} ] \\ {v}_{abc} = \sqrt{\frac{2}{3}} \cdot [ \begin{matrix}1 & - \frac{1}{2} & - \frac{1}{2} \\ 0 & \sqrt{\frac{3}{2}} & - \sqrt{\frac{3}{2}}\end{matrix} ] [ \begin{matrix}{v}_{a} \\ {v}_{b} \\ {v}_{c}\end{matrix} ] & ( 3 ) \\ {i}_{αβ} = [ \begin{matrix}{i}_{α} \\ {i}_{β}\end{matrix} ] = \sqrt{\frac{2}{3}} \cdot [ \begin{matrix}1 & - \frac{1}{2} & - \frac{1}{2} \\ 0 & \sqrt{\frac{3}{2}} & - \sqrt{\frac{3}{2}}\end{matrix} ] \\ {i}_{abc} = \sqrt{\frac{2}{3}} \cdot [ \begin{matrix}1 & - \frac{1}{2} & - \frac{1}{2} \\ 0 & \sqrt{\frac{3}{2}} & - \sqrt{\frac{3}{2}}\end{matrix} ] [ \begin{matrix}{i}_{a} \\ {i}_{b} \\ {i}_{c}\end{matrix} ] & ( 4 )\end{matrix}$$

Then, the instantaneous effective power calculation unit 626 calculates the instantaneous effective power P as

P=v_{α}·i_{α}+v_{β}·i_{β}

In the third instantaneous effective power calculation method, the two-phase AC voltages and two-phase AC currents in the stationary coordinate system (α-β coordinate system) are further coordinate-transformed into two-phase AC voltages and two-phase AC currents in a rotating coordinate system (d-q coordinate system) equivalent to the two-phase AC voltages and two-phase AC currents in the stationary coordinate system (the process generally known as the d-q transformation); then, the two-phase AC voltages and the two-phase AC currents in the rotating coordinate system (d-q coordinate system) are multiplied together on a phase-by-phase basis, and the sum of the products is taken as the calculation result. More specifically, the instantaneous effective power calculation unit 626 applies the following coordinate transformation (d-q transformation) to the two-phase AC voltage vector v_{αβ} and two-phase AC current vector i_{αβ} in the stationary coordinate system to transform them into the two-phase AC voltage vector v_{dq} and two-phase AC current vector i_{dq} in the rotating coordinate system.

$$\begin{matrix}{v}_{dq} = [ \begin{matrix}{v}_{d} \\ {v}_{q}\end{matrix} ] = [ \begin{matrix}cos θ & sin θ \\ - sin θ & cos θ\end{matrix} ] \\ {v}_{αβ} = [ \begin{matrix}cos θ & sin θ \\ - sin θ & cos θ\end{matrix} ] [ \begin{matrix}{v}_{α} \\ {v}_{β}\end{matrix} ] & ( 5 ) \\ {i}_{dq} = [ \begin{matrix}{i}_{d} \\ {i}_{q}\end{matrix} ] = [ \begin{matrix}cos θ & sin θ \\ - sin θ & cos θ\end{matrix} ] \\ {i}_{αβ} = [ \begin{matrix}cos θ & sin θ \\ - sin θ & cos θ\end{matrix} ] [ \begin{matrix}{i}_{α} \\ {i}_{β}\end{matrix} ] & ( 6 )\end{matrix}$$

where θ is the phase of the voltage vector v_{αβ}.

Then, the instantaneous effective power calculation unit 626 calculates the instantaneous effective power P as

P=v_{d}·i_{d}+v_{q}·i_{q}

When the input supply voltage is a three-phase symmetrical waveform with a phase voltage rms value E, the three-phase AC input voltage vector v_{abc}, the two-phase AC voltage vector v_{αβ} in the stationary coordinate system, and the two-phase AC voltage vector v_{dq} in the rotating coordinate system can be respectively expressed as

$$\begin{matrix}{v}_{abc} = \sqrt{2} E [ \begin{matrix}cos ( θ ) \\ cos ( θ - \frac{2 π}{3} ) \\ cos ( θ + \frac{2 π}{3} )\end{matrix} ] & ( 7 ) \\ {v}_{αβ} = \sqrt{3 } E [ \begin{matrix}cos θ \\ sin θ\end{matrix} ] & ( 8 ) \\ {v}_{dq} = [ \begin{matrix}\sqrt{3} E \\ 0\end{matrix} ] & ( 9 )\end{matrix}$$

Hence, the instantaneous effective power P is calculated as

P=√3·E·i_{d}∝i_{d}

which means that P is proportional to the d-phase current (effective current). Accordingly, the decision to stop the regenerative operation may be made by taking the d-phase current (effective current) as the calculation result of the instantaneous effective power calculation unit 626.

Next, based on the value of the power calculated by the instantaneous effective power calculation unit 626, the DC component calculation unit 628 calculates the DC component of the effective power supplied from the rectifier 108 to the inverter 106. More specifically, the DC component calculation unit 628 extracts the DC component such as shown in FIG. 5 by removing the harmonic components of the instantaneous effective power by using a moving average filter or a first-order low-pass filter.

Then, the regenerative operation stopping decision unit 632 compares the value of the DC component, calculated by the DC component calculation unit 628, with a predetermined threshold value and, if the value of the DC component is greater than the threshold value, determines that the regenerative operation stopping condition holds.

The switching pattern calculation unit 634 controls the rectifier 108 so as to perform the regenerative operation from the time the regenerative operation initiation decision unit 630 determines that the regenerative operation initiation condition holds, until the time the regenerative operation stopping decision unit 632 determines that the regenerative operation stopping condition holds. That is, by referring to the power supply phase information supplied from the power supply phase calculation unit 622, the switching pattern calculation unit 634 outputs semiconductor switch on/off signals, such as shown in FIG. 4, that match the respective power supply phases.

According to the above embodiment, since the decision as to whether or not to stop the regenerative operation is made based on the DC component (average power) extracted by removing the harmonic components from the effective power passing through the rectifier, the invention can ensure that the regenerative operation of the rectifier continues as long as the supply of power from the inverter is continuing, and that the regenerative operation of the rectifier stops when the supply of power from the inverter ends.

The invention may be embodied in other specific forms. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A motor driving apparatus equipped with a rectifier for converting AC power from a three-phase AC input power supply into DC power and an inverter for converting said DC power into AC power of desired frequency, and configured to perform power regeneration by controlling said rectifier, said motor driving apparatus comprising:
a detection unit which detects an input voltage and an input current supplied from said three-phase AC input power supply;
an instantaneous effective power calculation unit which, based on the input voltage and input current detected by said detection unit, calculates instantaneous effective power supplied from said rectifier to said inverter;
a DC component calculation unit which, based on the value of the power calculated by said instantaneous effective power calculation unit, calculates a DC component of the effective power supplied from said rectifier to said inverter; and
a regenerative operation stopping decision unit which compares the value of said DC component, calculated by said DC component calculation unit, with a predetermined threshold value and which, if the value of said DC component is greater than said threshold value, decides that a power regeneration operation for feeding regenerative power from said inverter back into said three-phase AC input power supply be stopped.

2. A motor driving apparatus as claimed in claim 1, wherein said DC component calculation unit calculates said DC component by using a moving average filter or a first-order low-pass filter.

3. A motor driving apparatus as claimed in claim 1, wherein said instantaneous effective power calculation unit outputs as a calculation result a sum of products each obtained by multiplying together, on a phase-by-phase basis, the input voltage and input current supplied from said three-phase AC input power supply and detected by said detection unit.

4. A motor driving apparatus as claimed in claim 1, wherein said instantaneous effective power calculation unit outputs as a calculation result a sum of products each obtained by coordinate-transforming (α-β transforming) the input voltage and input current supplied from said three-phase AC input power supply, and detected by said detection unit, into a two-phase AC voltage and a two-phase AC current in a stationary coordinate system (α-β coordinate system) equivalent to said input voltage and said input current in a three-phase AC coordinate system, and by multiplying together said two-phase AC voltage and said two-phase AC current on a phase-by-phase basis.

5. A motor driving apparatus as claimed in claim 1, wherein said instantaneous effective power calculation unit outputs as a calculation result a sum of products each obtained by coordinate-transforming (α-β transforming) the input voltage and input current supplied from said three-phase AC input power supply, and detected by said detection unit, into a two-phase AC voltage and a two-phase AC current in a stationary coordinate system (α-β coordinate system) equivalent to said input voltage and said input current in a three-phase AC coordinate system, by coordinate-transforming (d-q transforming) said two-phase AC voltage and said two-phase AC current in said stationary coordinate system (α-β coordinate system) into a two-phase AC voltage and a two-phase AC current in a rotating coordinate system (d-q coordinate system) equivalent to said two-phase AC voltage and said two-phase AC current in said stationary coordinate system, and by multiplying together said two-phase AC voltage and said two-phase AC current in said rotating coordinate system (d-q coordinate system) on a phase-by-phase basis.
